(19) United States
(12) Patent Application Publication
(10) Pub. No.: US 2008/0201322 A1
(43) Pub. Date: Aug. 21, 2008

(54) APPARATUS AND METHOD FOR RETRIEVAL OF CONTENTS

(75) Inventor: Hajime TERAYOKO, Saitama (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/953,989

(22) Filed: Dec. 11, 2007

(30) Foreign Application Priority Data
Feb. 21, 2007 (JP) 2007-041112

(51) Int. Cl. G06F 17/30; G06F 3/00

(52) U.S. Cl. 707/5; 707/E17.014

(57) ABSTRACT

A keyword determining section determines a keyword among a search query input by a user. A related word searching section searches a thesaurus database and retrieves words related to the determined keyword and information on relevancy of each related word to the keyword. Based on the keyword and its related words, an image searching section retrieves images from an image database. The search result by the image searching section is displayed on a monitor in a manner to reflect mutual relations between the retrieved images, such that images corresponding to the keyword are displayed in a center section, whereas images corresponding to broader or super-ordinate words to the keyword are arranged in an upper section, and images corresponding to narrower or subordinate words to the keyword are arranged in a lower section. Other images hit with synonyms and other related words to the keyword are arranged in side sections.

### FIELD OF THE INVENTION

The present invention relates to an apparatus and a method for retrieving some contents, particularly those for retrieving indefinite contents that have some relation to a keyword.

### BACKGROUND OF THE INVENTION

With the spread of information terminals such as cellular phones and personal computers, huge amounts of contents, including movies, images, music, games and electronic books, are getting available to anyone with ease nowadays. So there is an increasing demand to use the information terminals for contents-retrieval, and many suggestions have been made to help users retrieve efficiently such contents that meet the user's expectation.

As an exemplar of such improvements, JPA2005-310094 suggests using history data, in which keywords relevant to those contents which have been taken by a user are recorded in association with identification data of the user, to extend the search range by including those keywords, called extension keywords, which are relevant to an input keyword. On the basis of the extension keywords, such contents may be retrieved and provided as extended information or recommendation.

The above prior art also suggests changing the display condition of the retrieved contents depending upon the degree of affinity of the extension keywords with the input keyword. For example, only those contents are displayed, which contain such extension keywords that are highly similar to the input keyword. The higher the similarity of the extension keyword to the input keyword, are the retrieved contents displayed in the first or upper place or with some alert, e.g. attached with the larger number of asterisks. The degree of similarity is calculated using the number of extension keywords that are contained in information attached to the retrieved contents, the letter string length (the number of bytes) of the attached information, and a relation formula of the number of extension keywords.

In the above prior art, the mutual relations of the extension keywords to the input keyword are not reflected on the displayed retrieval result, so it is not always apparent to the user how and why such retrieval result is derived from the input keyword.

### SUMMARY OF THE INVENTION

In view of the foregoing, a primary object of the present invention is to provide a contents-retrieval apparatus and a contents-retrieval method, which are improved for the convenience of the users and facilitate understanding the relations between the retrieved contents and the input keyword.

According to the invention, an apparatus for contents retrieval comprises a contents storage device storing data of a variety of contents; a thesaurus storage device storing data of a thesaurus that classifies and organizes words according to their mutual relations; a search query input device; a keyword determining device for determining a keyword among a search query input through the search query input device; a related word searching device for searching the thesaurus for words related to the determined keyword, the related word searching device further obtaining information on relations of the retrieved related words to the keyword from the thesaurus; a contents searching device for retrieving such contents that correspond to the keyword and the retrieved related words from the contents storage device; and a display device for displaying a result of retrieval by the contents searching device, the display device displaying the retrieved contents on a screen in a manner variable according to the relations between the keyword and the related words, which correspond to the displayed contents.

According to a preferred embodiment, the display device decides positions of the retrieved contents on the screen to reflect the relations between the corresponding keyword and related words. Preferably, the display device displays the contents corresponding to the keyword in a center area of the screen.

It is also preferable that the display device displays the contents corresponding to the keyword in a larger size than the contents corresponding to the related words, especially where the contents are images.

The related word searching device preferably scores the degree of relevancy of each related word to the keyword.

The contents storage device preferably stores additional information on the contents in association with the respective contents, so that the contents searching device searches for the corresponding contents while comparing the keyword and the related words with the additional information.

The contents retrieval apparatus of the invention is preferably provided with a device for regularizing spelling variation in the keyword and/or a device for searching for synonyms to the keyword so that the related word searching device counts the synonyms in the keywords and searches for related words to these keywords.

It is also preferable to provide the contents retrieval apparatus of the invention with a device for judging whether a word retrieved as a related word by the related word searching device is an antonym to the keyword, so that the related word searching device excludes the retrieved word from the related words if the retrieved word is judged to be antonymous to the keyword.

According to the invention, a method for contents retrieval comprises steps of:

determining a keyword among an input search query;

retrieving related words to the determined keyword from a thesaurus that classifies and organizes words according to their mutual relations;

obtaining information on relations of the retrieved related words to the keyword from the thesaurus;

retrieving such contents that correspond to the keyword and the retrieved related words from among a variety of contents; and

displaying the retrieved contents on a screen in a manner variable according to the relations of the related words to the keyword, which correspond to the displayed contents.

Since the contents retrieved based on the keyword and its related words are displayed on a screen in a manner variable according to the relations of the related words to the keyword, the present invention facilitates understanding the relations between the retrieved contents and the input keyword, and thus helps the users retrieve expected contents conveniently.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram illustrating a hardware structure of an image registering retrieving system;

FIG. 2 is a block diagram illustrating an internal structure of a personal computer of the image registering retrieving system;

FIG. 3 is a block diagram illustrating an internal structure of an image registering retrieving server;

FIG. 4 is an explanatory diagram illustrating an example of a structure of a thesaurus;

FIG. 5 is a block diagram illustrating functional sections built in a CPU as a viewer software program starts up and an image retrieval mode is selected;

FIG. 6 is an explanatory diagram illustrating a search result display window displayed on a monitor;

FIG. 7 is a flowchart illustrating a sequence of processing for image retrieval;

FIG. 8 is a block diagram illustrating another embodiment of functional sections built in the CPU as a viewer software program starts up and an image retrieval mode is selected;

FIG. 9 is a flowchart illustrating part of a sequence of processing for image retrieval according to the embodiment of FIG. 8;

FIG. 10 is a block diagram illustrating a further embodiment of functional sections built in the CPU as a viewer software program starts up and an image retrieval mode is selected; and

FIG. 11 is a flowchart illustrating part of a sequence of processing for image retrieval according to the embodiment of FIG. 10.

### DESCRIPTION OF THE PREFERRED EMBODIMENTS

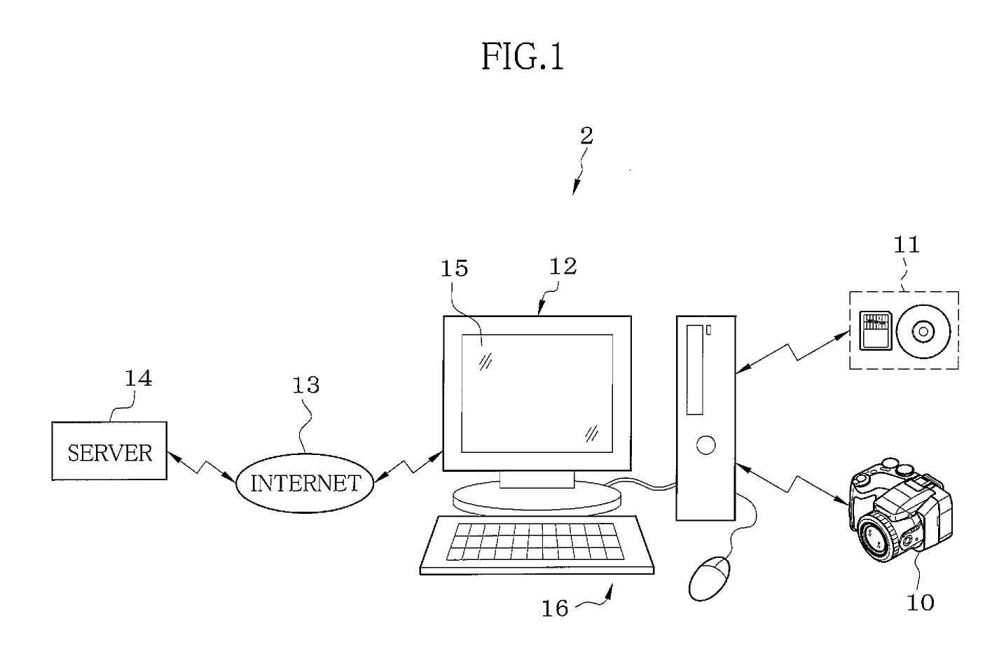

FIG. 1 shows an image registering retrieving system 2, in which image data obtained by a digital camera 10 or recorded on a recording medium 11 like a memory card or a CD-R are read into a personal computer 12, and the personal computer 12 is accessible to an image registering retrieving server 14 through the Internet 13 to register images in the server 14 or retrieve images from the server 14. Note that the image data include those obtained by digitizing images recorded on photographic film into TIFF or JPEG format.

For mutual data communication, the digital camera 10 is connected to the personal computer 12 through a communication cable, e.g. an IEEE1394 type or an USB (universal serial bus) type, or a wireless LAN. The recording medium 11 can also communicate data with the personal computer 12 through a specific driver.

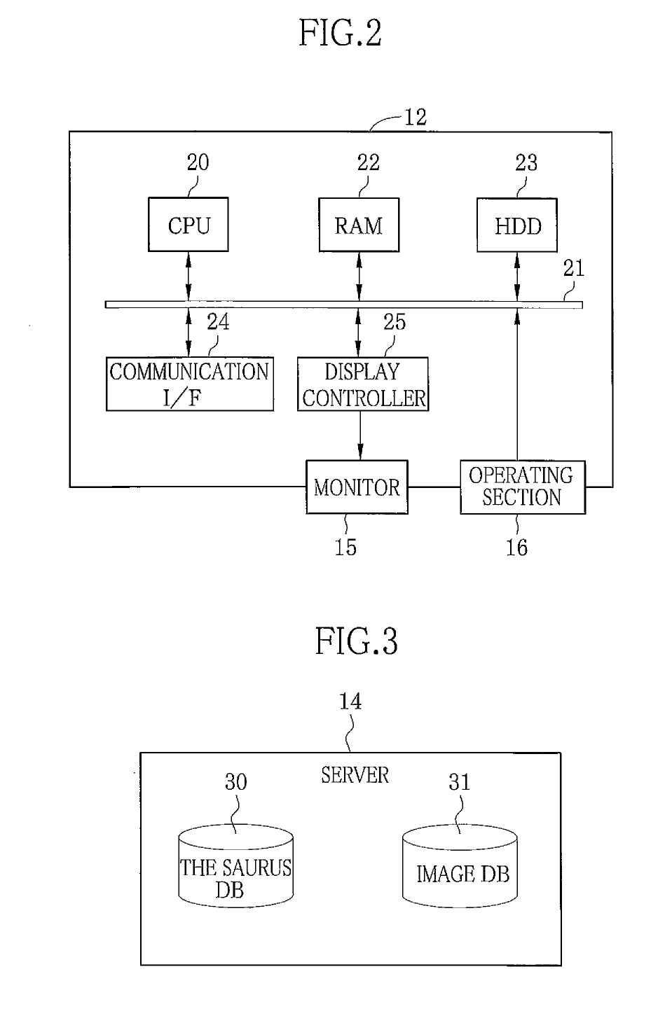

The personal computer 12 is provided with a monitor 15 and an operating section 16 consisting of a keyboard and a mouse. Referring to FIG. 2 showing the interior of the personal computer 12, a CPU 20 supervises and controls the overall operation of the personal computer 12. The CPU 20 is connected to the operating section 16, a RAM 22, a hard disc drive (HDD) 23, a communication interface (I/F) 24 and a display controller 25 through a data bus 21.

The HDD 23 stores various programs and data for operating the personal computer 12, a program for viewer-software that totalizes registration and retrieval of images, and a number of image data files read out from the digital camera 10 and the recording medium 11. The CPU 20 reads the program out of the HDD 23 and develops it on the RAM 22 to process it sequentially. The CPU 20 controls respective components of the personal computer 12 according to operational signals input through the operating section 16.

The communication interface 24 interfaces the data communication between an external instrument like the digital camera 10 and a communication network like the Internet 13. The display controller 25 controls the monitor 15 to display appropriate screens.

As shown in FIG. 3, the server 14 is provided with a thesaurus database 30 and an image database 31. The thesaurus database 30 stores data of a Japanese thesaurus that classifies and organizes Japanese words and terms according to their mutual relations, such as their hierarchical or class relationship, part-whole relationship, and synonymous relationship, i.e. relations between words with similar meanings. The image database 31 stores image data registered by the user of the image registering retrieving system 2 in association with additional information, e.g. the title of each image, tag or comments on the image and the like, which is input by the user at the registration.

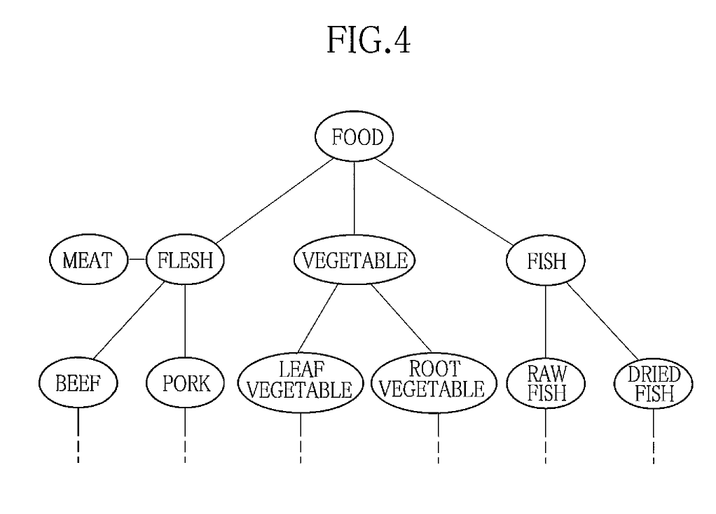

The thesaurus dictionary classifies words in a tree structure, wherein subordinate words, i.e. words with narrower meanings, are branched from a super-ordinate word, i.e. a word with a broader meaning. As shown for example in FIG. 4, “flesh”, “vegetable” and “fish” are branched from “food”. Furthermore, subordinate words to “flesh” such as “beef” and “pork” are tied to “flesh”, subordinate words to “vegetable” such as “leaf vegetable” and “root vegetable” are tied to “vegetable”, and subordinate words to “fish” such as “raw fish” and “dried fish” are tied to “fish”. Besides, “meat” is tied as a synonym to “flesh”. Although it is omitted from the drawing, related words are further tied to the respective subordinate words such as “beef” and “pork”.

On registering and retrieving some images, the user starts up the viewer software by operating the operating section 16. As the viewer software starts up, an authentication procedure is carried out to certify an access to the server 14. Upon the access being certified, it becomes possible to register and retrieve images. The viewer software is provided with an image registration mode and an image retrieval mode. To register some images, a list of images stored in the HDD 23 are displayed as thumbnails on the monitor 15, and the user selects the images from the list by operating the operating section 16, and inputs additional information, such as title, tag and comments, on each of the selected images. Then, the selected images are registered. To retrieve some images, the user operates the operating section 16 to input a string of letters or characters as a search query.

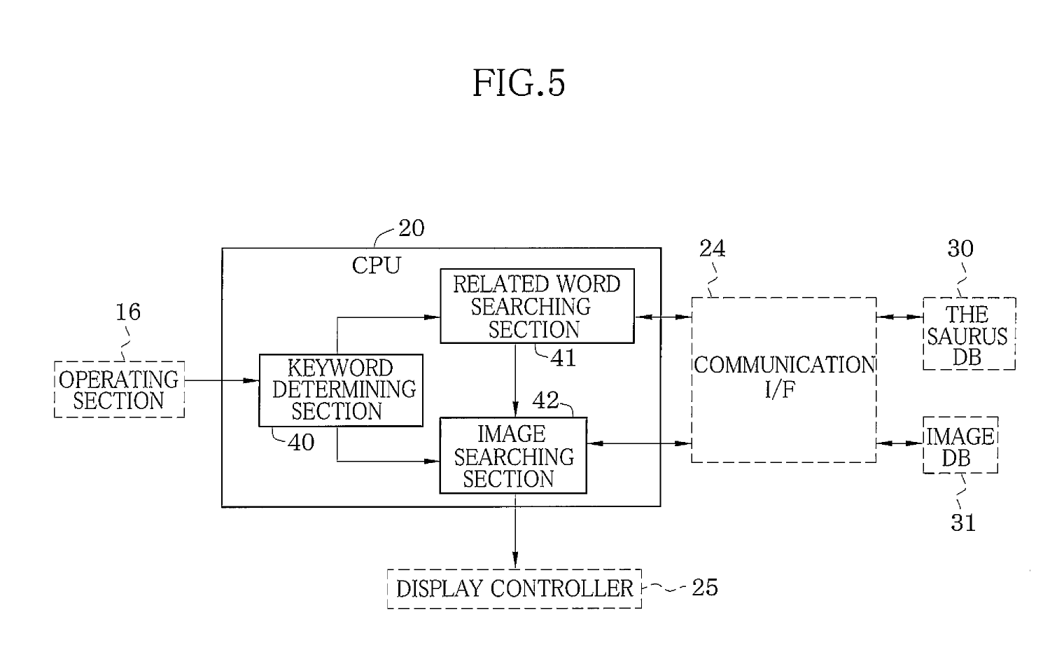

When the image retrieval mode of the viewer software is selected, the CPU 20 constructs a keyword determining section 40, a related word searching section 41 and an image searching section 42, as shown in FIG. 5.

The keyword determining section 40 analyzes the letter string input through the operating section 16 to determine the keywords for searching. For example, if the input letter spring is a noun like “flower” and “lion”, the keyword determining section 40 recognizes the input letter string itself as a keyword. If the input letter spring is a sentence like “I am looking for pictures of red cars”, the keyword determining section 40 subjects the input letter string to a syntactic analysis for analyzing the grammatical construction of the sentence and a morphemic analysis for dividing the sentence into morphemes (the minimum linguistic unit that makes sense) and parsing them. On the basis of the analysis results, the keyword determining section 40 extracts a term or word that is appropriate for a search term or keyword. In this example, “red car” is determined to be the keyword. If the input letter string directly designates the kind of images, e.g. “images of Tokyo tower”, a word that is probably contained in the additional information on the designated images, “Tokyo tower” in this example, is regarded as a keyword, wherein the additional information is input by the user at the time of registering each image. The keyword determining section 40 outputs data of the determined keyword to the related word searching section 41 and to the image searching section 42.

The related word searching section 41 accesses to the thesaurus database 30 through the communication interface 24, searching the thesaurus database 30 for words related to the keyword determined by the keyword determining section 40. The related word searching section 41 also retrieves relevancy information on these related words from the thesaurus database 30. The relevancy information indicates how these related words relate to the input keyword. As for the example of FIG. 4, if the input keyword is “food”, all the subordinate words which are branched from the word “food”, including “flesh”, “meat” and “beef”, are retrieved as the related words.

On retrieving the related word, the related word searching section 41 scores the degrees of relevancy of each word to the input keyword. For example, the related word searching section 41 converts the distance in meaning between the input keyword and the retrieved related word to a numerical value. Concretely, the input keyword is assumed to have a perfect score, e.g. 100 points, and its related words are scored in mark-back system: a synonym is −1 point, a broader term and a narrower word are −2 points, and an anonym is −3 points. A narrower term subordinate to a synonym to the keyword is (−1)+(−2)=−3 points, and a term still narrower than a narrower term is (−2)+(−2)=−4 points. Referring again to the example of FIG. 4, if the keyword is “food”, the score of its subordinate word “flesh” is 100−2=98. The word “beef” that is subordinate to the word “flesh” gets a score of 96 (=100−2−2). The score of “meat”, a synonym to “flesh”, is 97 (=100−2−1). The related word searching section 41 retrieves a predetermined number of related words or ones above a predetermined score, and outputs information on the retrieved related words to the image searching section 42. Simultaneously, the related word searching section 41 obtains the relevancy information from the thesaurus database 30. The respective scores of the related words and the relevancy information on the related words are temporarily stored in the RAM 22.

The image searching section 42 receives information on the keyword from the keyword determining section 40 and information on the related words from the related word searching section 41, and makes an access to the image database 31 through the communication interface 24, to search the communication interface 24 for such images that match with the received keyword and the received related words. The image searching section 42 compares the information on the keyword and related words with the additional information of the stored images, to check if the keyword or any related word is contained in the title or the tag or the comments of each image. Thus, the communication interface 24 retrieves a predetermined number of images and outputs data of the retrieved images to the display controller 25.

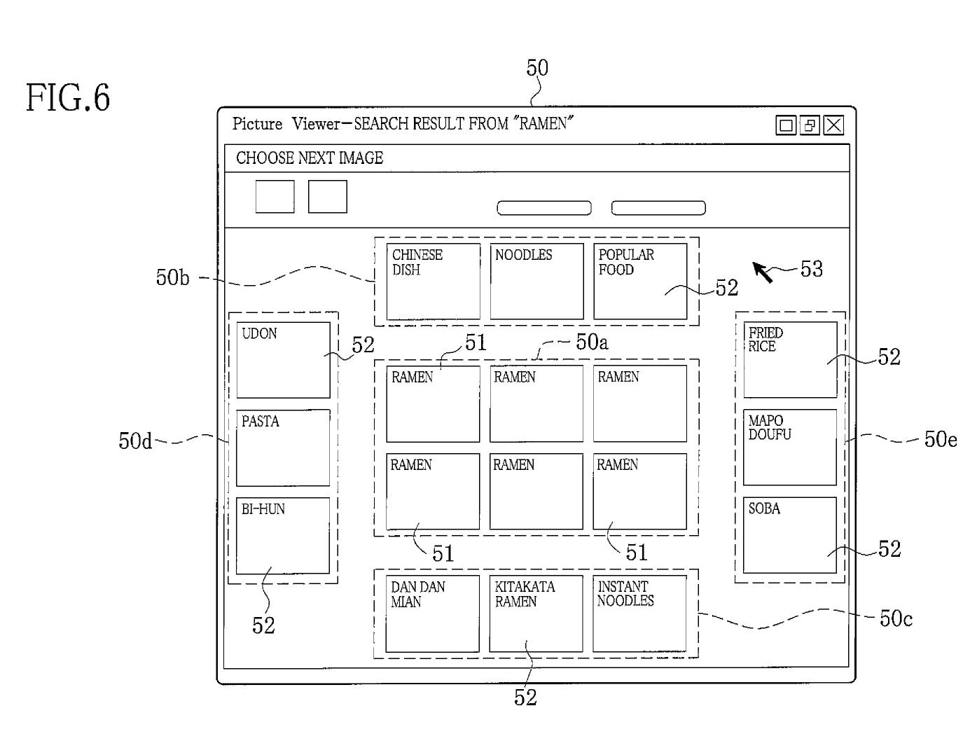

On the basis of the image data from the image searching section 42, as well as the respective scores of the retrieved related words and their relevancy information stored in the RAM 22, the display controller 25 controls the monitor 15 to display a search result display window 50, as shown for example in FIG. 6. In the search result display window 50, those images 51 being retrieved based on the keyword, hereinafter referred to as keyword images 51, are arranged in a center section 50a, whereas those images 52 being retrieved based on the related words, hereinafter referred to as related images 52, are arranged in peripheral sections 50b, 50c, 50d and 50e. Specifically, the related images 52 hit with the broader or super-ordinate words to the keyword are arranged in the upper section 50b: “Chinese dish”, “noodles” and “popular food” are referred to as the broader words super-ordinate to the keyword “ramen (Chinese noodles)” in the illustrated example. The related images 52 hit with the narrower or subordinate words, e.g. “dandan mian” and “instant noodle”, are arranged in the lower section 50c. Other related images 52 hit with the synonyms and other related words to the keyword, such as “udon (thick wheat flour noodles)” and “soba (buckwheat noodles)” are arranged in the side sections 50d and 50d. Six keyword images 51 are displayed in a matrix of 2×3, whereas a single related image is displayed to one related word. The display controller 25 determines the arrangement of the images 51 and 52 in the respective sections 50a to 50e of the search result display window 50 with reference to the relevancy information. In order to facilitate recognizing visually the degree of relations of the related images 52, the display sections 50a to 50e or the related images 52 may be displayed in variable sizes or at variable intervals according to the scores of the corresponding related words.

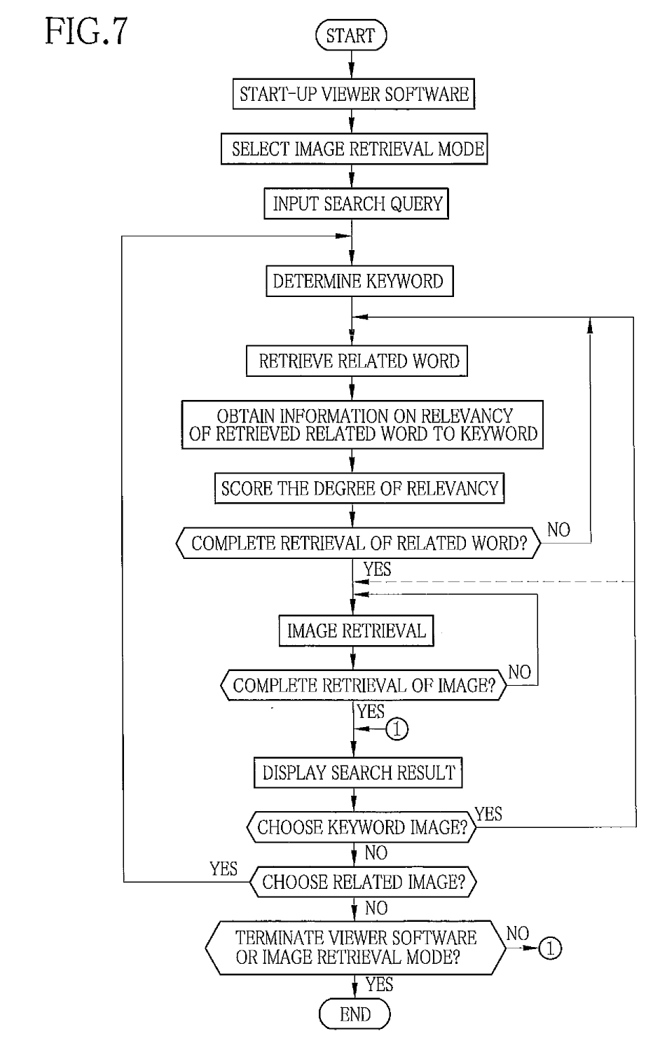

Now the processing procedure of the image registering retrieving system 2 as constructed above will be described with reference to the flowchart of FIG. 7. As the viewer software is started up and the image retrieval mode is selected, the keyword determining section 40, the related word searching section 41 and the image searching section 42 are built up on the CPU 20.

The user operates the operating section 16 to input an arbitrate string of letters for searching. The, the keyword determining section 40 analyzes the input letter string through the syntactic and morphemic analyses to determine a keyword for searching. Information on the determined keyword is output to the related word searching section 41 and the image searching section 42.

Upon receipt of the keyword from the keyword determining section 40, the related word searching section 41 accesses to the thesaurus database 30 through the communication interface 24, to retrieve related words to the keyword and the relevancy information on these related words to the keyword from the thesaurus database 30. The related word searching section 41 scores the degree of relevancy of each related word to the keyword. The related word searching section 41 continues retrieving the related words and scoring their relevancy degrees till it retrieves a predetermined number of related words or ones above a predetermined score. After the completion of retrieval, information on the retrieved related words is output to the image searching section 42. The score and the relevancy information of each related word is temporarily stored in the RAM 22.

In response to the information on the input keyword from the keyword determining section 40 and the information on the related words from the related word searching section 41, the image searching section 42 accesses to the image database 31 through the communication interface 24 to search for some keyword images and related images. After a predetermined number of images are retrieved, data of the retrieved images and the information on the score and relevancy of each related word, as stored in the RAM 22, are sent to the display controller 25, so the display controller 25 controls the monitor 15 to display the search result display window 50.

When the user puts a pointer 53 on one of the keyword images 51 in the search result display window 50 and clicks the mouse of the operating section 16 thereon, the related word searching section 41 retrieves different related words from the already retrieved ones, or as indicated by dashed lines in FIG. 7, the image searching section 42 retrieves different images from the already retrieved ones. Based on the new retrieval result, the search result display window 50 changes its display contents.

When the user puts the pointer 53 on one of the related images 52 and clicks thereon, the keyword determining section 40 determines the word corresponding to the chosen related image 52 to be a new keyword. Then, words relevant to the new keyword and images corresponding to the new keyword and its related words are retrieved in the same way as described above, and the search result display window 50 changes its display contents correspondingly. Past records on the display contents of the search result display window 50 as well as on the chosen images 51 and 52 are temporarily stored in the RAM 22, so the search result display window 50 may return to the previous display screen. Thus, the user can browse a wide variety of images, including those retrieved based on such words relating to the related words to the keyword, by choosing the images 51 and 52 one after another, without the need for inputting another keyword or letter string. As the images corresponding to the keyword and the related words are simultaneously retrieved and displayed on the same screen, the user may enjoy browsing the images just like surfing on the sea of information. So the image registering retrieving system 2 is very convenient for the user to search for indefinite contents.

As described so far, the images 51 and 52 are displayed according to the degrees of relevancy of the related words to the keyword, so that the relations between the keyword image 51 and the related images 52 may be visually recognizable. Therefore, the convenience of the user on searching is still more improved.

In Japanese writing system, letter strings that may be input as search terms (keywords or key phrases) can be written in different scripts, such as kanji (Chinese characters), hiragana, katakana, roman letters, one-byte characters, double-byte characters, capital letters and small letters. That is, the user can use the different scripts for expressing the same word. For example, the word for “dog” may be written in hiragana, katakana or kanji characters. Furthermore, there are cases where different Kanji characters are used to spell the same word according to its application fields. For example, different kanji characters for expressing a term for “superconductivity” are respectively used in JIS standard, i.e. in the industrial field and in academic parlance, i.e. in the academic field. Also, there are cases where several different katakana-spellings are used for a foreign or imported word, for example, “interface”. There are also spelling variation or representation variation between modern and classic kanji characters, as well as differences in declensional Kana ending or in punctuation. Besides, the input letter strings can contain erratum and omission of characters.

Moreover, Japanese language contains plenty of synonyms in comparison with other languages. Take the word “I” for example, the pronoun used by a speaker when talking about himself or herself, there are tens of synonyms in Japanese: “watashi”, “boku”, “ore”, “waqahai”, “shousei” etc. There are also a huge number of abbreviations, like “Toudai” for “Tokyo-daigaku (The university of Tokyo)”, or “Souri” for “Naikaku-Souridaijin (prime minister)”, as well as a huge number of common names, like “Shusho” for “Naikaku-souridaijin”. Hereinafter, the above-mentioned tolerated variations and potential mistakes in spelling will be called the spelling variation.

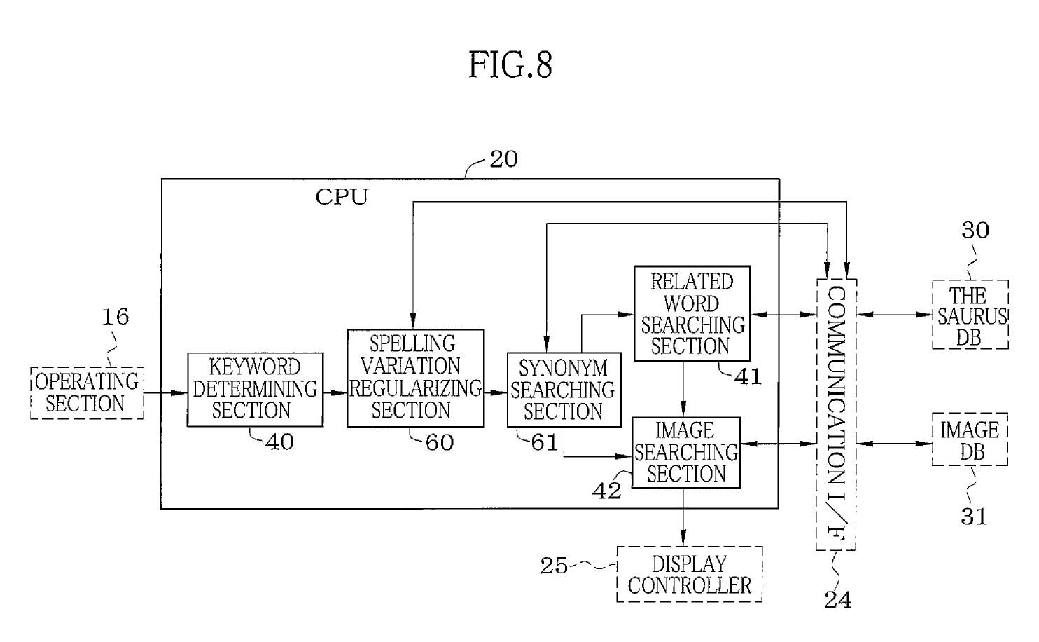

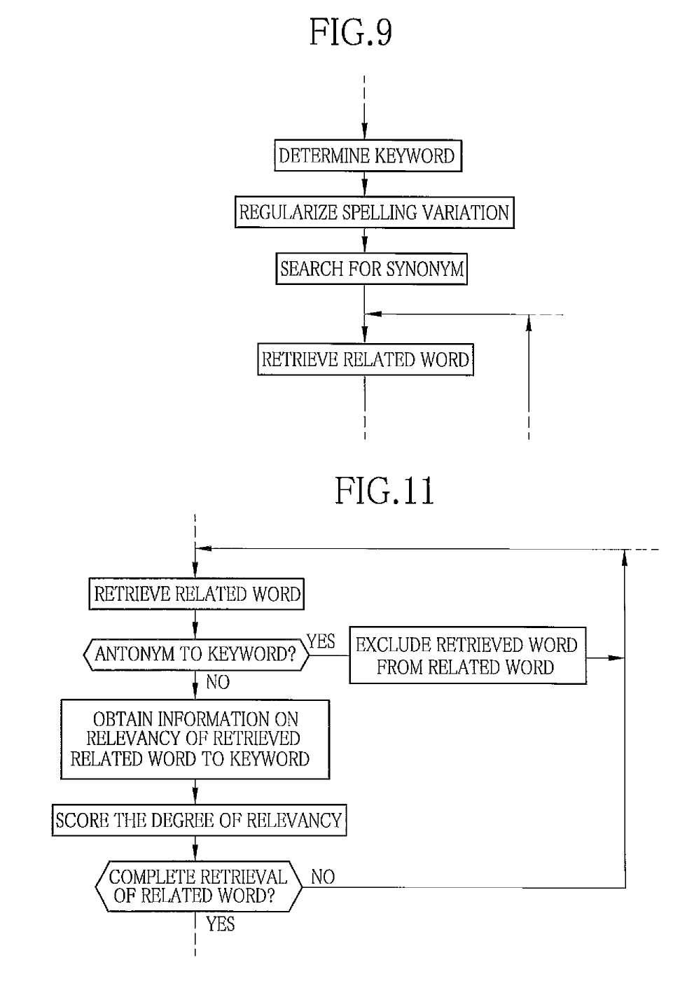

For this reason, it is preferable providing a spelling variation regularizing section 60 and a synonym search section 61 behind the keyword determining section 40, as shown in FIG. 8. According to this embodiment, the spelling variation regularizing section 60 reads information on the spelling variation out of the thesaurus database 30, converts one-byte characters to double-byte ones, or converts small letters to capital letters, to regularize the input keyword, as shown in FIG. 9, wherein processes before the keyword determination and after the related word search correspond to those shown in FIG. 7, so these processes are omitted from the flowchart of FIG. 9. The synonym searching section 61 accesses to the thesaurus database 30 through the communication interface 24 to search for synonyms to the input keyword. Then the related word searching section 41 regards the retrieved synonyms as identical to the input keyword, and retrieves related terms to the retrieved synonyms. Thus, the range of searching is widened to retrieve such words and images that have some relation to the input keyword but would not be retrieved through the strict search based on the input keyword alone. So the search accuracy is improved.

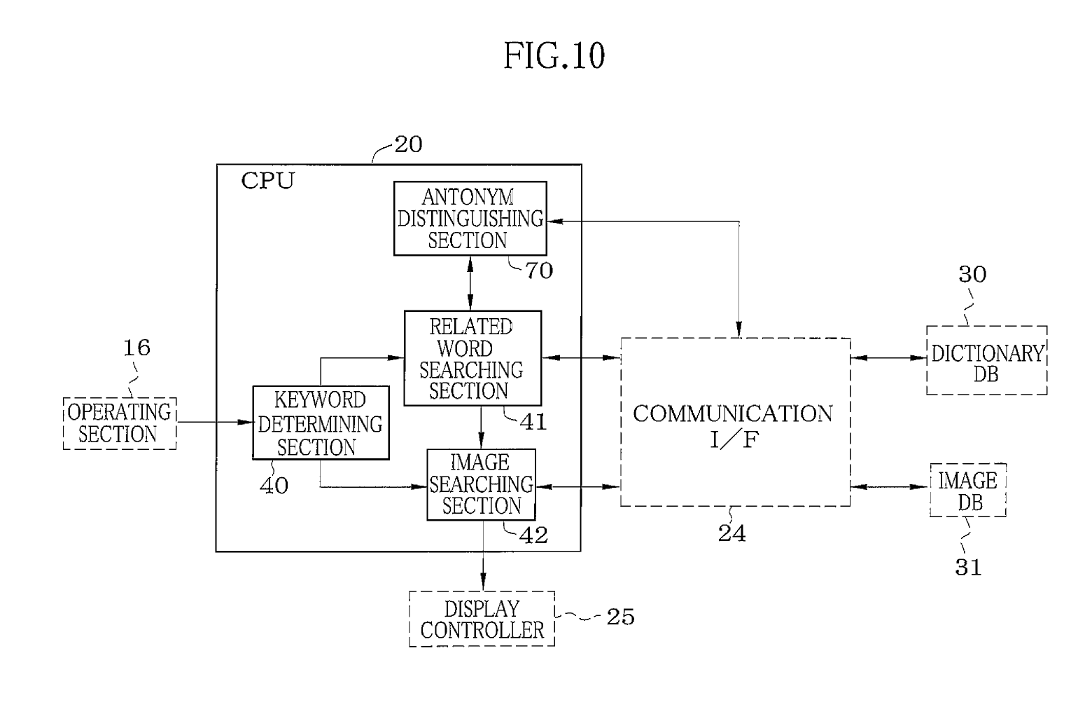

It is also possible to provide an antonym distinguishing section 70, as shown in FIG. 10. According to this embodiment, the antonym distinguishing section 70 judges whether a word retrieved as a related word by the related word searching section 41 is an antonym to the input keyword, as shown in FIG. 11, wherein processes before the related word search and after the inquiry about whether the related word search is complete correspond to those shown in FIG. 7, so these processes are omitted from the flowchart of FIG. 11. If the antonym distinguishing section 70 judges that the retrieved word is antonymous to the input keyword, the related word searching section 41 cancels the retrieval of this word and searches for another related word. The antonym distinguishing section 70 makes the judgment as to whether a word is antonymous to the keyword or not, referring to information on antonyms, which is read out from the thesaurus database 30. Alternatively, the antonym distinguishing section 70 can make the judgment on a retrieved word with reference to its related words. For example, “summer” may be retrieved as a related word to “winter” because they express seasons. However, because an adjective “hot” is related to “summer”, whereas an adjective “cold” is related to “winter”, and these adjectives are antonymous, “summer” can be judged to be an antonym to “winter”. In this way, it becomes possible to retrieve such related words that meet the user's expectation better.

Although the number of related words and the number of images retrieved based on a keyword are predetermined in the above embodiment, it is possible that the user can preset and change the numbers of retrieved words and images. For scoring the degree of relevancy of each related word to the keyword, another method is usable instead of the above-mentioned mark-back system. For example, it is possible to register scores of the respective words previously in the thesaurus database 30. It is also possible to weight the scores according to the words, so that a word which is distant in the meaning from a keyword but is tightly associated with the keyword, e.g. “top of Japan” to “Mt. Fuji”, will get a high score. Furthermore, it is possible to record the history about the choice of the related images 52, so that those words which are chosen frequently will get higher scores.

Although the above-described embodiment refers to images as the contents to be retrieved, the present invention is applicable to other cases where the retrieval contents are movies, music, games, electronic books and the like. The present invention is also applicable to retrieval of commercial articles on websites.

In the above-described embodiment, the devices 40 to 42 for executing the image retrieval are built in the CPU 20 when the user starts up the viewer software program and selects the image retrieval mode. But it is possible to mount the devices 40 to 42 as hardware components, e.g. in the form of discrete circuits or FPGA (field programmable gate array), in the personal computer 12. It is also possible to construct the devices 40 to 42 as separate members that are connectable to the personal computer 12. The spelling variation regularizing section 60 and the synonym searching section 61 may be provided in the keyword determining section 40. Also, the antonym distinguishing section 70 may be provided in the related word searching section 41.

Thus, the present invention is not to be limited to the above-described embodiments but, on the contrary, various modifications will be possible without departing from the scope of claims appended hereto.

What is claimed is:

1. An apparatus for contents retrieval comprising:
a contents storage device storing data of a variety of contents;
a thesaurus storage device storing data of a thesaurus that classifies and organizes words according to their mutual relations;
a search query input device;
a keyword determining device for determining a keyword among a search query input through said search query input device;
a related word searching device for searching said thesaurus for words related to the determined keyword, said related word searching device further obtaining information on relations of the retrieved related words to the keyword from said thesaurus;
a contents searching device for retrieving such contents that correspond to the keyword and the retrieved related words from said contents storage device; and
a display device for displaying a result of retrieval by said contents searching device, said display device displaying the retrieved contents on a screen in a manner variable according to the relations between the keyword and the related words, which correspond to the displayed contents.

2. An apparatus for contents retrieval as recited in claim 1, wherein said display device decides positions of the retrieved contents on the screen to reflect the relations between the corresponding keyword and related words.

3. An apparatus for contents retrieval as recited in claim 2, wherein said display device displays the contents corresponding to the keyword in a center area of the screen.

4. An apparatus for contents retrieval as recited in claim 1, wherein said display device displays the contents corresponding to the keyword in a larger size than the contents corresponding to the related words.

5. An apparatus for contents retrieval as recited in claim 1, wherein said related word searching device scores the degree of relevancy of each related word to the keyword.

6. An apparatus for contents retrieval as recited in claim 1, wherein said contents storage device stores additional information on the contents in association with the respective contents, and said contents searching device searches for the corresponding contents while comparing the keyword and the related words with said additional information.

7. An apparatus for contents retrieval as recited in claim 1, further comprising a device for regularizing spelling variation in the keyword.

8. An apparatus for contents retrieval as recited in claim 1, further comprising a device for searching said thesaurus for synonyms to the keyword, wherein said related word searching device counts the synonyms in the keywords and searches for related words to these keywords.

9. An apparatus for contents retrieval as recited in claim 1, further comprising a device for judging whether a word retrieved as a related word by said related word searching device is an antonym to the keyword, wherein said related word searching device excludes said retrieved word from the related words if said retrieved word is judged to be antonymous to the keyword.

10. An apparatus for contents retrieval as recited in claim 1, wherein the contents comprise images.

11. A method for contents retrieval comprising steps of:
determining a keyword among an input search query;
retrieving related words to the determined keyword from a thesaurus that classifies and organizes words according to their mutual relations;
obtaining information on relations of the retrieved related words to the keyword from said thesaurus;
retrieving such contents that correspond to the keyword and the retrieved related words from among a variety of contents; and
displaying the retrieved contents on a screen in a manner variable according to the relations of the related words to the keyword, which correspond to the displayed contents.

12. A method for contents retrieval as recited in claim 11, wherein positions of the contents displayed on the screen are decided to reflect the relations between the corresponding related words and the keyword.

13. A method for contents retrieval as recited in claim 12, wherein said contents comprise images, and images retrieved based on the keyword are displayed in a center section on the screen, whereas images retrieved based on broader or super-ordinate words to the keyword are displayed in an upper section on the screen, images retrieved based on narrower or subordinate words to the keyword are displayed in a lower section on the screen, and images retrieved based on synonyms and other related words to the keyword are displayed in side sections on the screen.

14. A method for contents retrieval as recited in claim 11, wherein said contents comprises images, and images corresponding to the keyword are displayed in a larger size than images corresponding to the related words.

15. A method for contents retrieval as recited in claim 14, wherein the images corresponding to the related words are displayed in different sizes according to the degree of relevancy of the related words to the keyword.

16. A method for contents retrieval as recited in claim 11, further comprising a step of scoring the degree of relevancy of each related word to the keyword.

17. A method for contents retrieval as recited in claim 11, further comprising steps of storing additional information on the contents in association with the respective contents, and comparing the keyword and the related words with said additional information to retrieve the corresponding contents.

18. A method for contents retrieval as recited in claim 11, further comprising a step of regularizing spelling variation in the keyword.

19. A method for contents retrieval as recited in claim 11, further comprising a step of searching for synonyms to the keyword and counting the synonyms in the keywords on searching for the related words.

20. A method for contents retrieval as recited in claim 11, further comprising a step of distinguishing and excluding antonyms to the keyword from the retrieved related words.
